(19) United States
(12) Patent Application Publication
(10) Pub. No.: US 2014/0357767 A1
(43) Pub. Date: Dec. 4, 2014

(54) POLYCARBONATE COMPOSITIONS WITH IMPROVED MELT STABILITY

(71) Applicants: Rolf Wehrmann, Krefeld (DE); Helmut-Werner Heuer, Krefeld (DE)

(72) Inventors: Rolf Wehrmann, Krefeld (DE); Helmut-Werner Heuer, Krefeld (DE)

(73) Assignee: Bayer Intellectual Property GmbH, Monheim (DE)

(21) Appl. No.: 14/463,026

(22) Filed: Aug. 19, 2014

Related U.S. Application Data
(63) Continuation of application No. 13/498,990, filed on May 2, 2012.

(30) Foreign Application Priority Data
Sep. 30, 2009 (DE) 102009043510.7

(51) Int. Cl. C08K 5/521; C08K 5/527; C08K 5/3475; C08K 5/101; C08K 5/524; C08K 5/50; C08K 5/315; C08K 5/5393; C08K 5/3492

(52) U.S. Cl. CPC C08K 5/521; C08K 5/5393; C08K 5/527; C08K 5/3475; C08K 5/3492; C08K 5/524; C08K 5/50; C08K 5/315; C08K 5/101
USPC 524/91; 524/145; 524/135; 524/120; 524/100

(57) ABSTRACT

The invention relates to polycarbonate compositions and copolycarbonate compositions with improved melt stability, the preparation thereof and the use thereof for the production of mouldings and mouldings obtainable therefrom, wherein the compositions contain a polycarbonate or copolycarbonate containing bisphenol A, and at least one phosphorus compound of the formulae (1) and (2), wherein R1 and R2 independently of each other and among one another are chosen from the group which includes branched alkyl radicals, aryl radicals and substituted aryl radicals.

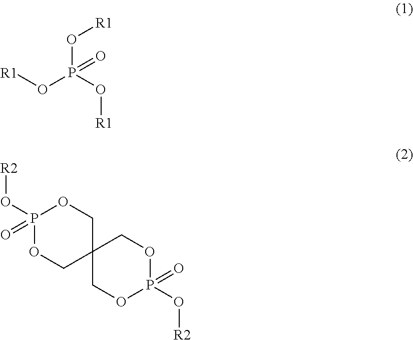

The invention relates to polycarbonate compositions and copolycarbonate compositions with improved melt stability, the preparation thereof and the use thereof for the preparation of compositions, e.g. blends, and mouldings obtainable therefrom. In particular, compositions which contain substances containing phenol groups, such as additives, impurities or oligomers and residual monomers, and polycarbonates containing phenol groups are of particular interest here.

Polycarbonates belong to the group of industrial thermoplastics. They have diverse uses in the electrical and electronics sector, as a housing material for lamps and in uses where particular mechanical properties are required. A further large field of use is optical data storage media, such as the various CD and DVD formats as well as Blu-ray disc and HD-DVD, and extrusion uses, such as polycarbonate sheets, diffuser sheets for background illumination, LED uses and other display uses or water bottles, but also optical uses in the automobile sector, such as glazing, coverings of plastic, diffusing screens or light conductor elements collimators, lenses, polymeric light wave conductors, and lamp coverings for long field lamps.

In all these uses, mechanical properties and rheological properties, e.g. good flowability, with a simultaneously high thermal resistance, especially during processing, are always required.

This is of great importance in particular in the event of relatively long cycle times and unexpected disturbances in production with a forced higher exposure to heat in the mould. Good thermal properties require a high melt stability at temperatures above 300° C., which is obtained, inter alia, by minimizing secondary reactions in the melt.

In particular, the stability of the melt can be reduced by added additives or by-products inherently present, such as e.g. oligomers containing phenol groups, phenol end groups of the polymer backbone or also phenol itself, which lead to an undesirable degradation of the polycarbonate. This degradation then manifests itself in a lowering of the melt viscosity.

Accompanying this, a deterioration in the thermal and mechanical properties is always to be found. A reaction of added additives, such as e.g. colouring agents or UV absorbers, or of oligomeric constituents, residual monomers or polycarbonate with phenolic end groups inherently present, via phenolic OH groups thereof accordingly has an adverse effect on the melt stability.

In continuous preparation processes for polycarbonates, such as e.g. by the interfacial or melt polycondensation process, and/or subsequent processing steps, such as e.g. compounding, injection moulding or extrusion, the polycarbonate melts are exposed to a high thermal stress and high shearing energy in the processing units. As a result, damage may arise in the polymer, as described above inter alia due to secondary reaction, which manifests itself in a reduced heat stability, degradation of the polymer and an increased yellowness index during long-term use under the influence of heat.

There was therefore the object of developing aromatic polycarbonate compositions and copolycarbonates compositions with improved melt stability and a reduced potential for secondary reactions, while retaining other core properties.

The object of the invention was the development of a polycarbonate composition which has a good melt stability even during relatively high exposure to heat—e.g. disturbances in production (long dwell times of the material in the hot mould) or relatively high thermal stress when throughput is increased to increase the utilization of machine capacity.

Polycarbonate compositions with improved melt stability were thus to be provided for demanding injection moulding processes, such as e.g. 2-component injection moulding or injection-compression moulding processes, for example for the production of large mouldings, such as automobile glazing or sunroofs or covering screens for front lights.

EP 0023291 describes stabilized thermoplastic moulding compositions based on polycarbonates, ABS polymers and bridged phosphorus acid esters.

Phosphites of oxidation level +3 have the disadvantage that they severely adversely influence the hydrolysis properties of the polycarbonates or polycarbonate blends containing corresponding additives.

However, in polycarbonate compositions these substances have no stabilizing action on the constancy of the melt and do not prevent undesirable secondary reactions, which manifest themselves in a change, in particular a lowering, of the viscosity during the processing process and thus in the end lead to an unstable, varying processing process. Merely protection against purely thermal degradation, which manifests itself in yellowing during long-term storage (conventional thermal ageing), is described.

However, the prior art gives no indications at all of the influence of phosphates, diphosphates or mixtures of phosphates with other heat stabilizers, such as e.g. phosphites, phosphines or phosphonites, in polycarbonates and compounds thereof and the influence thereof on the melt stability.

It has been found, surprisingly, that added phosphates of the formulae (1) and (2) lead to an improved melt stability.

The present invention therefore provides polycarbonate compositions containing phosphates of the formulae (1) and (2) or mixtures of these phosphates

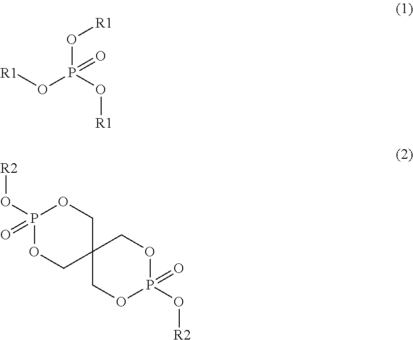

wherein R1 and R2 independently of each other and among one another represent branched alkyl radicals and/or optionally substituted aryl radicals, wherein the alkyl radical is preferably a C₁-C₁₈-alkyl, more preferably a C₁-C₈-alkyl.

The aryl radical is preferably substituted by C₁-C₈-alkyl, branched C₁-C₈-alkyl or cumyl, wherein the substituents can be identical or different, but identical substituents are preferred.

The aryl radicals are preferably substituted in positions 2 and 4 or 2, 4 and 6.

tert-Butyl substituents in these positions are very particularly preferred.

The compounds (1) and (2) are preferably added to a polycarbonate melt in situ in a continuous polycarbonate preparation process or a compounding process, directly or in the form of a masterbatch via a side unit, preferably with exclusion of air.

The compounds of the formulae (1) and (2) are employed in amounts of from 5 to 1,500 ppm, preferably 10 to 1,200 ppm, more preferably 20 to 1,000 ppm and particularly preferably 25 to 800 ppm, and very particularly preferably from 30 to 300 ppm.

Polycarbonate compositions containing compounds of the formula (3)

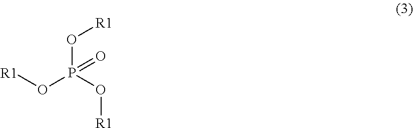

where R1=C₁-C₈-alkyl, are particularly preferred.

Polycarbonate compositions containing compounds of the formula (4) (tri-isooctyl phosphate, TOF):

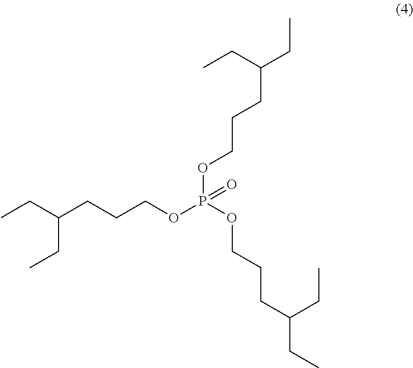 [SMILES: CCC(CC)CCCOP(=O)(OCCCC(CC)CC)OCCCC(CC)CC]

are very particularly preferred.

Further conventional heat stabilizers, such as e.g. additives based on structural elements of the formulae (5) to (8), can optionally be added.

These compounds with structural elements of the formulae (5) to (8) are called secondary antioxidants (hydroperoxide decomposers; Plastics Additives Handbook, 5th edition, Hanser Verlag Munich, 2001). Primary antioxidants (free radical scavengers), e.g. sterically hindered phenols or HALS stabilizers, can optionally also additionally be added (Plastics Additives Handbook, 5th edition, Hanser Verlag Munich, 2001).

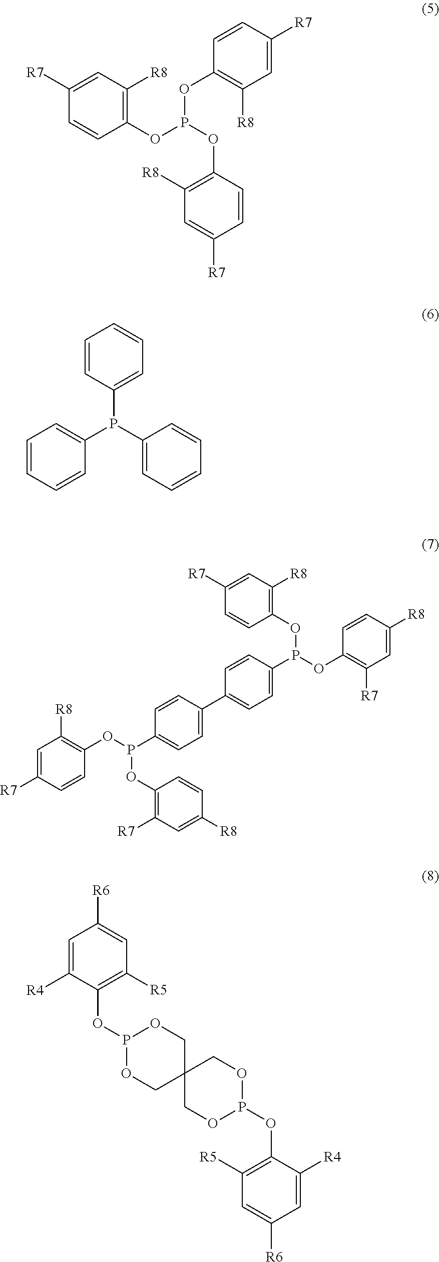

wherein R4, R5, R6, R7 and R8 in each case independently of each other and among one another represent H, a C₁-C₈-alkyl radical, a phenyl radical or a substituted phenyl radical. The phenyl radical is preferably substituted by C₁-C₈-alkyl, branched C₁-C₈-alkyl or cumyl, wherein the substituents can be identical or different, but identical substituents are preferred.

Preferably, R4, R5, R6, R7 and R8 represent branched C₁-C₈-alkyl or cumyl, particularly preferably tert-butyl or cumyl.

The content of these heat stabilizers, based on the total mass of the composition, is preferably 30 to 600 ppm, further preferably 50 to 500 ppm, and particularly preferably 500 ppm.

The ratio of secondary antioxidants to the phosphates according to the invention can be between 10:1 to 1:10, preferably 8:1 to 1:8, particularly preferably 6:1 to 1:6 and very particularly preferably 4:1 to 1:4.

Thermoplastic aromatic polycarbonates in the context of the present invention are both homopolycarbonates and copolycarbonates; the polycarbonates can be linear or branched in a known manner.

The thermoplastic polycarbonates and copolycarbonates, including the thermoplastic aromatic polyester carbonates, both summarized under the term polycarbonate, have molecular weights M_{w} (weight-average Mw, determined by gel permeation chromatography (GPC) measurement, polycarbonate calibration) of from 10,000 to 200,000, preferably from 15,000 to 100,000 and particularly preferably 17,000-70,000 g/mol.

The present invention furthermore provides compositions containing the abovementioned polycarbonate compositions with phosphorus compounds of the formulae (1) and (2) and at least one additive chosen from the group consisting of UV stabilizer and mould release agent and optionally colouring agent.

The composition in general contains 0.01 to 3.000, preferably 0.02 to 1.50, more preferably from 0.03 to 1.00 and particularly preferably 0.04 to 0.80 wt. % (based on the total composition) of additives.

Organic UV stabilizers are suitable as UV stabilizers. The UV stabilizers are preferably chosen from the group which includes benzotriazoles (e.g. Tinuvins from Ciba), triazines (CGX-06 from Ciba), benzophenones (Uvinuls from BASF), cyanoacrylates (Uvinuls from BASF), cinnamic acid esters and oxalanilides and mixtures of these UV stabilizers.

Examples of suitable UV absorbers are:

a) Malonates of the formula (1):

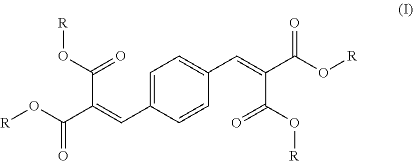

wherein R denotes alkyl. Preferably, R represents C1-C6-alkyl, in particular C1-C4-alkyl and particularly preferably ethyl.

b) Benzotriazole derivatives according to formula (II):

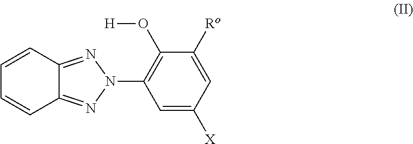

In formula (II), R^{o} and X are identical or different and denote H or alkyl or alkylaryl.

In this context, Tinuvin® 329, where X=1,1,3,3-tetramethylbutyl and R^{o}=H, Tinuvin® 350, where X=tert-butyl and R^{o}=2-butyl, and Tinuvin® 234, where X and R^{o}=1,1-dimethyl-1-phenyl, are preferred.

c) Dimeric benzotriazole derivatives according to formula (III):

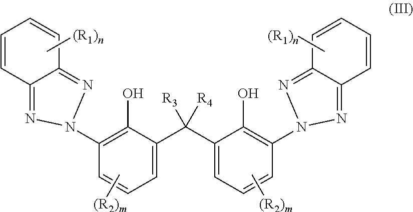

In formula (III), R₁ and R₂ are identical or different and denote H, halogen, C1-C10-alkyl, C5-C10-cycloalkyl, C7-C13-aralkyl, C6-C14-aryl, —OR5 or —(CO)—O—R5, where R5=H or C1-C4-alkyl.

In formula (III), R₃ and R₄ are likewise identical or different and denote H, C1-C4-alkyl, C5-C6-cycloalkyl, benzyl or C6-C14-aryl.

In formula (III), m denotes 1, 2 or 3 and n denotes 1, 2, 3 or 4.

In this context, Tinuvin® 360, where R₁=R₃=R₄=H; n=4; R₂=1,1,3,3-tetramethylbutyl; m=1 is preferred.

d) Dimeric benzotriazole derivatives according to formula (IV):

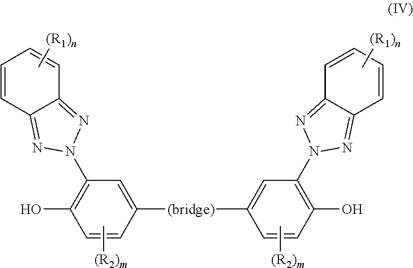

wherein the bridge denotes

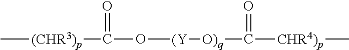

R₁, R₂, m and n have the meaning given for formula (III), and wherein p is an integer from 0 to 3, q is an integer from 1 to 10, Y is —CH₂—CH₂—, —(CH₂)₃—, —(CH₂)₄—, —(CH₂)₅—, (CH₂)₆— or CH(CH₃)—CH₂— and R³ and R⁴ have the meaning given for formula (III).

In this context, Tinuvin® 840, where R₁=H; n=4; R₂=tert-butyl; m=1; R₂ is attached in the ortho position relative to the OH group; R³=R⁴=H; p=2; Y=—(CH₂)₅—; q=1, is preferred.

e) Triazine derivatives according to formula (V):

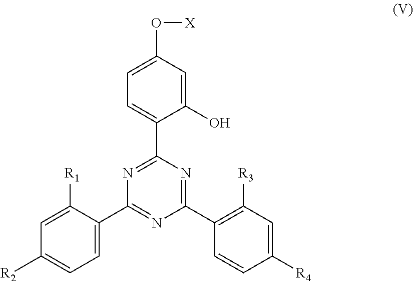

wherein R₁, R₂, R₃, R₄ are identical or different and are H, alkyl, aryl, CN or halogen and X is alkyl, preferably iso-octyl.

In this context, Tinuvin® 1577, where R₁=R₂=R₃=R₄=H; X=hexyl, and Cyasorb UV-1 164, where R₁=R₂=R₃=R₄=methyl; X=octyl, are preferred.

f) Triazine derivatives of the following formula (Va):

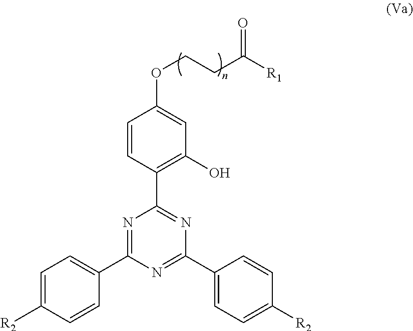

wherein R₁ denotes C1-alkyl to C17-alkyl, R₂ denotes H or C1-alkyl to C4-alkyl and n is 0 to 20.

g) Dimeric triazine derivatives of the formula (VI:)

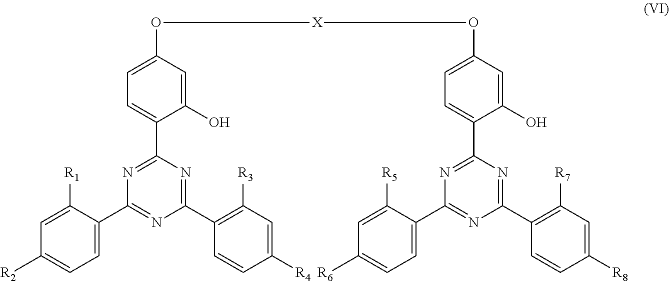

wherein R₁, R₂, R₃, R₄, R₅, R₆, R₇, R₈ can be identical or different and denote H, alkyl, CN or halogen and X is alkylidene, preferably methylidene or —(CH₂CH₂—O—)-n-C(═O)— and n represents 1 to 10, preferably 1 to 5, in particular 1 to 3.

h) Diaryl cyanoacrylates of the formula (VII):

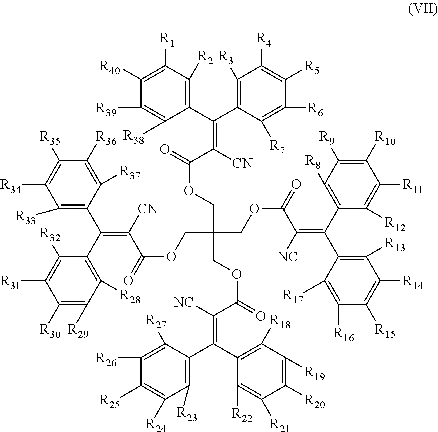

wherein R₁ to R₄₀ can be identical or different and denote H, alkyl, CN or halogen.

In this context, Uvinul® 3030, where R₁ to R₄₀=H, is preferred.

Particularly preferred UV stabilizers for the moulding compositions according to the invention are compounds from the group consisting of the benzotriazoles (b) and dimeric benzotriazoles (c and d), the malonates (a) and the cyanoacrylates (h) and mixtures of these compounds.

The UV stabilizers are employed in amounts of from 0.01 wt. % to 1.00 wt. %, preferably in amounts of from 0.05 wt. % to 0.80 wt. %, particularly preferably in amounts of from 0.08 wt. % to 0.5 wt. % and very particularly preferably in amounts of from 0.1 wt. % to 0.4 wt. %, based on the total composition.

If the composition is used as a masterbatch for the UV absorber or as a coextruded layer, the content of UV absorber can be 3-20 wt. %, preferably 5-8 wt. %, based on the total composition.

The mould release agents optionally added to the compositions according to the invention are preferably chosen from the group which includes pentaerythritol tetrastearate, glycerol monostearate, stearyl stearate and propanediol stearate and mixtures thereof. The mould release agents are employed in amounts of from 0.05 wt. % to 2.00 wt. %, based on the moulding composition, preferably in amounts of from 0.1 wt. % to 1.0 wt. %, particularly preferably in amounts of from 0.15 wt. % to 0.60 wt. % and very particularly preferably in amounts of from 0.2 wt. % to 0.5 wt. %, based on the moulding composition.

Primary antioxidants which are employed are, preferably, sterically hindered phenols (e.g. Irganox types from Ciba, for example Irganox 1076 (octadecyl 3-(3,5-di-tert-butyl-4-hydroxyphenyl)-propionate), Irganox 1010 (pentaerythritol tetrakis(3-(3,5-di-tert-butyl-4-hydroxyphenyl)-propionate) or Irganox 1035 (thiodiethylene bis(3-(3,5-di-tert-butyl-4-hydroxyphenyl)-propionate).

The compositions according to the invention can furthermore contain conventional additives, such as other heat stabilizers, antistatics, colouring agents, flow auxiliaries and flameproofing agents.

The preparation of the polycarbonates to be used according to the invention is in principle carried out in a known manner from diphenols, carbonic acid derivatives and optionally branching agents.

The process for polycarbonate synthesis is generally known and is described in numerous publications. EP-A 0 517 044, WO 2006/072344, EP-A 1 609 818, WO 2006/072344 and EP-A 1 609 818 and documents cited there describe, for example, the interfacial and the melt process for the preparation of polycarbonate.

Dihydroxyaryl compounds which are suitable for the preparation of polycarbonates are those of the formula (9)

HO—Z—OH (9)

in which
Z is an aromatic radical having 6 to 30 C atoms, which can contain one or more aromatic nuclei, can be substituted and can contain aliphatic or cycloaliphatic radicals or alkylaryls or hetero atoms as bridge members.

Preferably, in formula (9) Z represents a radical of the formula (10)

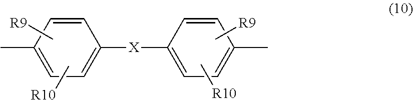

in which
R9 and R10 independently of each other represent H, C₁-C₁₈-alkyl, C₁-C₁₈-alkoxy, halogen, such as Cl or Br, or in each case optionally substituted aryl or aralkyl, preferably H or C₁-C₁₂-alkyl, particularly preferably H or C₁-C₈-alkyl and very particularly preferably H or methyl, and
X represents a single bond, —SO₂—, —CO—, —O—, —S—, C₁- to C₆-alkylene, C₂- to C₅-alkylidene or C₆- to C₁₂-arylene, which can optionally be condensed with further aromatic rings containing hetero atoms.

Preferably, X represents a single bond, C₁ to C₅-alkylene, C₂ to C₅-alkylidene, C₅ to C₁₂-cycloalkylidene, —O—, —SO—, —CO—, —S— or —SO₂—, and X particularly preferably represents a single bond, isopropylidene, C₅ to C₁₂-cycloalkylidene or oxygen.

Diphenols which are suitable for the preparation of the poly carbonates to be used according to the invention are, for example, hydroquinone, resorcinol, dihydroxydiphenyl, bis-(hydroxyphenyl)-alkanes, bis-(hydroxyphenyl)-cycloalkanes, bis-(hydroxyphenyl) sulfides, bis-(hydroxyphenyl) ethers, bis-(hydroxyphenyl) ketones, bis-(hydroxyphenyl) sulfones, bis-(hydroxyphenyl) sulfoxides, α,α′-bis-(hydroxyphenyl)-diisopropylbenzenes, and alkylated, nucleus-alkylated and nucleus-halogenated compounds thereof.

Preferred diphenols are 4,4′-dihydroxydiphenyl, 2,2-bis-(4-hydroxyphenyl)-1-phenylpropane, 1,1-bis-(4-hydroxyphenyl)-phenylethane, 2,2-bis-(4-hydroxyphenyl)-propane, 2,2-bis-(3-methyl-4-hydroxyphenyl)-propane, 2,4-bis-(4-hydroxyphenyl)-2-methylbutane, 1,3-bis-[2-(4-hydroxyphenyl)-2-propyl]-benzene (bisphenol M), 2,2-bis-(3-methyl-4-hydroxyphenyl)-propane, bis-(3,5-dimethyl-4-hydroxyphenyl)-methane, 2,2-bis-(3,5-dimethyl-4-hydroxyphenyl)-propane, bis-(3,5-dimethyl-4-hydroxyphenyl) sulfone, 2,4-bis-(3,5-dimethyl-4-hydroxyphenyl)-2-methylbutane, 1,3-bis-[2-(3,5-dimethyl-4-hydroxyphenyl)-2-propyl]-benzene and 1,1-bis-(4-hydroxyphenyl)-3,3,5-trimethylcyclohexane.

Particularly preferred diphenols are 2,2-bis-(4-hydroxyphenyl)-propane (BPA), 4,4′-dihydroxydiphenyl (DOD), 2,2-bis-(3-methyl-4-hydroxyphenyl)-propane and 1,1-bis-(4-hydroxyphenyl)-3,3,5-trimethylcyclohexane (TMC).

These and further suitable diphenols are described e.g. in U.S. Pat. Nos. 2,999,835, 3,148,172, 2,991,273, 3,271,367, 4,982,014 and 2,999,846, in the German Offenlegungsschriften 1 570 703, 2 063 050, 2 036 052, 2 211 956 and 3 832 396, French Patent Specification 1 561 518, in the monograph “H. Schnell, Chemistry and Physics of Polycarbonates, Interscience Publishers, New York 1964, p. 28 et seq.; p. 102 et seq.”, and in “D. G. Legrand, J. T. Bendler, Handbook of Polycarbonate Science and Technology, Marcel Dekker New York 2000, p. 72 et seq.”.

In the case of homopolycarbonates only one diphenol is employed, and in the case of copolycarbonates two or more diphenols are employed. The diphenols used, like all the other chemicals and auxiliary substances added to the synthesis, may be contaminated with impurities originating from their own synthesis, handling and storage. However, it is desirable to work with raw materials which are as pure as possible.

The polycarbonate synthesis is carried out continuously. The reaction in the interface (SPC process) can be carried out in pumped circulation reactors, tube reactors or stirred tank cascades or combinations thereof, where it is to be ensured, by using the mixing organs already mentioned, that the aqueous and organic phase as far as possible only demix when the synthesis mixture has reacted completely, i.e. no longer contains hydrolysable chlorine from phosgene or chlorocarbonic acid esters.

The amount of chain terminators in the form of monophenols, such as phenol, tert-butylphenol or cumylphenol, to be employed is 0.5 mol % to 10.0 mol %, preferably 1.0 mol % to 8.0 mol %, particularly preferably 2.0 mol % to 6.0 mol %, based on the moles of the particular diphenols employed. The addition of the chain terminators can be carried out before, during or after the phosgenation, preferably as a solution in a solvent mixture of methylene chloride and chlorobenzene (8-15 wt. % strength).

The catalysts used in the interfacial synthesis are tertiary amines, in particular triethylamine, tributylamine, trioctylamine, N-ethylpiperidine, N-methylpiperidine or N-i/n-propylpiperidine, particularly preferably triethylamine and N-ethylpiperidine. The catalysts can be added to the synthesis individually, in a mixture or also side by side and successively, optionally also before the phosgenation, but meterings after the introduction of phosgene are preferred. Metering of the catalyst or catalysts can be carried out in substance, in an inert solvent, preferably that of the polycarbonate synthesis, or also as an aqueous solution, in the case of the tertiary amines then as ammonium salts thereof with acids, preferably mineral acids, in particular hydrochloric acid. If several catalysts are used or part amounts of the total amount of the catalyst are metered in, it is of course also possible to carry out different methods of metering in at various sites or various times. The total amount of catalysts used is between 0.001 to 10.000 mol %, based on the moles of bisphenols employed, preferably 0.01 to 8.00 mol %, particularly preferably 0.05 to 5.00 mol %.

The organic phase is washed repeatedly with desalinated or distilled water. The organic phase, where appropriate dispersed with parts of the aqueous phase, is separated off after the individual washing steps by means of settling tanks, stirred tanks, coalescers or separators or combinations of these measures, it being possible for the wash water to be metered between the washing steps, optionally using active or passive mixing organs.

The polymer can be isolated from the solution by evaporation of the solvent by means of heat, vacuum or a heated entraining gas.

The residues of the solvent can be removed from the highly concentrated polymer melts obtained in this way either directly from the melt with devolatilization extruders, thin film evaporators, falling film evaporators or extrusion evaporators, or by friction compacting, optionally also with the addition of an entraining agent, such as nitrogen or carbon dioxide, or using vacuum, or alternatively also by subsequent crystallization and thorough heating of the residues of the solvent in the solid phase.

The reaction in the melt (melt polycondensation process, MPC process) can be carried out by the transesterification process discontinuously or also continuously. When the dihydroxyaryl compounds and diaryl carbonates, optionally with further compounds, are present as a melt, the reaction is started in the presence of a suitable catalyst. The conversion or the molecular weight is increased at increasing temperatures under decreasing pressures in suitable apparatuses and devices by removal of the monohydroxyaryl compound split off, until the end state aimed for is achieved. By choice of the ratio of dihydroxyaryl compound to diaryl carbonate, of the loss rate of the diaryl carbonate via the vapours determined by the choice of procedure or installation for the preparation of the polycarbonate, and of compounds optionally added, such as, for example, a higher-boiling monohydroxyaryl compound, the nature and concentration of end groups is determined.

Preferably, the continuous process for the preparation of polycarbonates is characterized in that one or more dihydroxyaryl compounds are melted with the diaryl carbonate, optionally also other reactants added, using the catalysts, and after a precondensation, without the monohydroxyaryl compound formed being separated off, the molecular weight is built up to the desired level in several subsequent reaction evaporator stages at temperatures increasing stepwise under pressures decreasing stepwise.

The devices, apparatuses and reactors suitable for the individual reaction evaporator stages are, according to the course of the process, heat exchangers, pressure-release apparatuses, separators, columns, evaporators, stirred tanks and reactors or other commercially obtainable apparatuses which provide the necessary dwell time at selected temperatures and pressures. The devices chosen must render possible the necessary introduction of heat and be constructed such that they meet the requirements of the continuously increasing melt viscosities.

All the devices are connected to one another via pumps, pipelines and valves. The pipelines between all the equipment should of course be as short as possible, and the curvatures of the lines should be kept as small as possible in order to avoid unnecessarily prolonged dwell times. In this context, the external, that is to say technical framework conditions and requirements for assembly of chemical installations are to be taken into account.

For carrying out the process by a preferred continuous procedure, either the reaction partners can be melted together, or the solid dihydroxyaryl compound can be dissolved in the diaryl carbonate melt or the solid diaryl carbonate can be dissolved in the melt of the dihydroxyaryl compound or the two raw materials are brought together as a melt, preferably directly from the preparation. The dwell times of the separate melts of the raw materials, in particular those of the melt of the dihydroxyaryl compound, are set as short as possible. On the other hand, the melt mixture can dwell longer at correspondingly lower temperatures without losses in quality because of the lowered melting point of the raw material mixture compared with the individual raw materials.

Thereafter, the catalyst, preferably dissolved in phenol, is admixed and the melt is heated to the reaction temperature. At the start of the industrially important process for the preparation of polycarbonate from 2,2-bis-(4-hydroxyphenyl)-propane and diphenyl carbonate, this is 180 to 220° C., preferably 190 to 210° C., very particularly preferably 190° C. At dwell times of from 15 to 90 min, preferably 30 to 60 min, reaction equilibrium is established without the hydroxyaryl compound formed being removed. The reaction can be carried out under atmospheric pressure, but for technical reasons also under increased pressure. The preferred pressure in industrial installations is 2 to 15 bar absolute.

The melt mixture is released into a first vacuum chamber, the pressure of which is set at 100 to 400 mbar, preferably to 150 to 300 mbar, and directly thereafter is heated again to the entry temperature in a suitable device under the same pressure. During the releasing operation the hydroxyaryl compound formed is evaporated with the monomers still present. After a dwell time of from 5 to 30 min in a bottom product receiver, optionally with pumped circulation, under the same pressure at the same temperature, the reaction mixture is released into a second vacuum chamber, the pressure of which is 50 to 200 mbar, preferably 80 to 150 mbar, and directly thereafter is heated to a temperature of from 190 to 250° C., preferably 210 to 240° C., particularly preferably 210 to 230° C., in a suitable device under the same pressure. Here also, the hydroxyaryl compound formed is evaporated with the monomers still present. After a dwell time of from 5 to 30 min in a bottom product receiver, optionally with pumped circulation, under the same pressure at the same temperature, the reaction mixture is released into a third vacuum chamber, the pressure of which is 30 to 150 mbar, preferably 50 to 120 mbar, and directly thereafter is heated to a temperature of from 220 to 280° C., preferably 240 to 270° C., particularly preferably 240 to 260° C., in a suitable device under the same pressure. Here also, the hydroxyaryl compound formed is evaporated with the monomers still present. After a dwell time of from 5 to 20 min in a bottom product receiver, optionally with pumped circulation, under the same pressure at the same temperature, the reaction mixture is released into a further vacuum chamber, the pressure of which is 5 to 100 mbar, preferably 15 to 100 mbar, particularly preferably 20 to 80 mbar, and directly thereafter is heated to a temperature of from 250 to 300° C., preferably 260 to 290° C., particularly preferably 260 to 280° C., in a suitable device under the same pressure. Here also, the hydroxyaryl compound formed is evaporated with the monomers still present.

The number of these stages, 4 by way of example here, can vary between 2 and 6. The temperatures and pressures are to be adapted accordingly if the number of stages changes, in order to obtain comparable results.

The relative viscosity of the precondensate of the oligomeric carbonate achieved in these stages is between 1.04 and 1.20, preferably between 1.05 and 1.15, particularly preferably between 1.06 to 1.10.

In a preferred embodiment, the oligocarbonate produced in this way is conveyed, after a dwell time of from 5 to 20 min in a bottom product receiver, optionally with pumped circulation, under the same pressure at the same temperature as in the last flash/evaporator stage, into a disc or basket reactor and subjected to a further condensation reaction at 250 to 310° C., preferably 250 to 290° C., particularly preferably 250 to 280° C., under pressures of from 1 to 15 mbar, preferably 2 to 10 mbar, over dwell times of from 30 to 90 min, preferably 30 to 60 min. The product reaches a relative viscosity of from 1.12 to 1.28, preferably 1.13 to 1.26, particularly preferably 1.13 to 1.24. The melt leaving this reactor (medium viscosity reactor) is brought to the desired end viscosity or the end molecular weight by separating of the condensation product, phenol, in a further disc or basket reactor (high viscosity reactor). The temperatures here are 270 to 330° C., preferably 280 to 320° C., particularly preferably 280 to 310° C., the pressure is 0.01 to 3.00 mbar, preferably 0.2 to 2.0 mbar, over dwell times of from 60 to 180 min, preferably 75 to 150 min. The rel. viscosities are set at the level necessary for the envisaged use and are 1.18 to 1.40, preferably 1.18 to 1.36, particularly preferably 1.18 to 1.34.

The function of the two basket reactors can also be combined in one basket reactor.

The vapours from all the process stages are removed directly, collected and worked up. This working up is as a rule carried out by distillation in order to achieve high purities of the products.

Granules are obtained, if possible, by direct spinning of the melt and subsequent granulation, or by using melt extruders, from which spinning is carried out in air or under liquid, usually water. If extruders are used, additives can be added to the melt before this extruder, optionally using static mixers, or through side extruders in the extruder.

Before the spinning (granulation), the compounds of the formulae (1) and/or (2) are fed into the melt via a side unit (side extruder) as the pure substance or as a masterbatch in polycarbonate (max. 10 wt. %). This masterbatch can optionally contain further additives, such as light stabilizers, mould release agents, heat stabilizers or colouring additives.

The addition of additives serves to prolong the duration of use by stabilizers, which prevent degradation of the constituents of the composition, to impart colour to the end product, to simplify the processing (e.g. mould release agents, flow auxiliaries, antistatics) or to adapt the polymer properties to exposure to particular stresses (impact modifiers, such as rubbers; flameproofing agents, colouring agents, glass fibres).

These additives can be added to the polymer melt individually or in any desired mixtures or several different mixtures, and in particular directly during isolation of the polymer or after melting of granules in a so-called compounding step. In this context, the additives or mixtures thereof can be added to the polymer melt as a solid, that is to say as a powder, or as a melt. Another type of metering in is the use of masterbatches or mixtures of masterbatches of the additives or additive mixtures.

Suitable conventional additives for polycarbonate compositions are described, for example, in “Additives for Plastics Handbook, John Murphy, Elsevier, Oxford 1999”, in “Plastics Additives Handbook, Hans Zweifel, Hanser, Munich 2001” or in WO 99/55772, p. 15-25.

Colouring agents, such as organic dyestuffs or pigments, or inorganic pigments, IR absorbers, individually, in a mixture or also in combination with stabilizers, glass (hollow) beads, inorganic fillers or organic or inorganic scattering pigments, can furthermore be added.

The polycarbonate compositions according to the invention can be processed in the conventional manner on conventional machines, for example on extruders or injection moulding machines, to give any desired shaped articles, or mouldings to give films or sheets or bottles.

The polycarbonate compositions with improved melt properties according to the present invention which are obtainable in this way can be employed for the production of extrudates (sheets, films and laminates thereof; e.g. for card uses and tubes) and shaped articles (bottles), in particular those for use in the transparent sector, especially in the field of optical uses, such as e.g. sheets, multi-wall sheets, glazing, diffusing or covering screens, lamp coverings, covering screens of plastic, light conductor elements or optical data storage media, such as audio-CD, CD-R(W), DVD, DVD-R(W), minidisks in their various only readable or once-writable and optionally also rewritable embodiments, and data carriers for near-field optics, and furthermore for the production of objects for the electrical/electronics fields and IT sector.

A further large field of use for the polycarbonate compositions according to the invention are diffuser sheets for background illuminations, diffusing screens and other display uses, but also optical uses in the automobile sector, such as glazing, coverings of plastic, sunroofs, UV-protected diffusing and covering screens, light conductor elements, collimators, lenses, LED uses, polymer light conductor elements and lamp coverings for long field lamps.

The polycarbonate compositions of the present invention are used in particular for the preparation of compounds, blends, such as e.g. PC/ABS, PC/ASA, PC/SAN, PC/PBT. PC/PET or PC/PETG, and components which impose particular requirements on optical and mechanical properties, such as, for example, housings, objects in the E/E sector, such as plugs, switches, panels, lamp holders and coverings in the automobile sector, lamp holders and coverings, glazing, the medical sector, such as dialysers, connectors, taps, packaging, such as bottles, containers.

The present application likewise provides the extrudates and shaped articles or mouldings from the polymers according to the invention.

### EXAMPLES

### Table 1

Polycarbonate compositions based on Makrolon 2808 (BPA polycarbonate with an MVR of 10 cm³/10 min at 300° C./1.2 kg, Bayer MaterialScience) are provided with the additives listed in Table 1 on a twin-screw extruder at 280° C.

0.01 wt. % of tri-isooctyl phosphate (TOF, Lanxess) is additionally added to the polycarbonate compositions according to the invention.

PETS: pentaerythritol tetrastearate; Loxiol VPG 861 from Cognis

Tin 329: Tinuvin 329; hydroxybenzotriazole UV absorber from BASF/Ciba

TPP: triphenylphosphine from BASF

PEPQ: Irgafos P PEPQ; dimeric phosphonite from BASF/Ciba (formula 7, where R7 and R8=tert-butyl).

Irgafos 168: phosphite from BASF/Ciba (formula 5, where R7 and R8=tert-butyl)

Irganox B900: mixture of Irgafos 168 and Irganox 1076 (sterically hindered phenol) in the ratio 4:1 from BASF/Ciba

Doverphos S 9228-PC: dimeric phosphite from Dover, USA (formula 8, where R4=H and R5, R6=cumyl)

TABLE 1

| Polycarbonate composition | | 1 | 2 | 3 | 4 | 5 | 6 | 7 | 8 | 9 | 10 |
|---|---|---|---|---|---|---|---|---|---|---|---|
| Makrolon 2808 | % | 99.455 | 99.445 | 99.455 | 99.445 | 99.455 | 99.445 | 99.455 | 99.445 | 99.455 | 99.445 |
| PETS | % | 0.27 | 0.27 | 0.27 | 0.27 | 0.27 | 0.27 | 0.27 | 0.27 | 0.27 | 0.27 |
| TIN 329 | % | 0.25 | 0.25 | 0.25 | 0.25 | 0.25 | 0.25 | 0.25 | 0.25 | 0.25 | 0.25 |
| TPP | % | 0.025 | 0.025 | — | — | — | — | — | — | — | — |
| PEPQ | % | — | — | 0.025 | 0.025 | — | — | — | — | — | — |
| Irgafos 168 | % | — | — | — | — | 0.025 | 0.025 | — | — | — | — |
| Irganox B900 | % | — | — | — | — | — | — | 0.025 | 0.025 | — | — |
| Doverphos S-9228 | % | — | — | — | — | — | — | — | — | 0.025 | 0.025 |
| TOF | % | — | 0.01 | — | 0.01 | — | 0.01 | — | 0.01 | — | 0.01 |

After drying at 120° C. overnight, the polycarbonate compositions obtained in this way are exposed to a temperature of 320° C. for different lengths of time (20 and 30 minutes). After the particular exposure time has elapsed, the MVR is measured under in each case 1.2 kg. The MVR values obtained in this way are entered into Table 2.

TABLE 2

| | Results | | | | | | | | | |
|---|---|---|---|---|---|---|---|---|---|---|
| | 1 | 2 | 3 | 4 | 5 | 6 | 7 | 8 | 9 | 10 |
| | TPP | TPP + TOF | PEPQ | PEPQ + TOF | I168 | I168 + TOF | B900 | B900 + TOF | S9228 | S9228 + TOF |
| TOF content mg/kg | — | 71 | — | 71 | — | 69 | — | 74 | — | 72 |
| MVR 300° C. ml/10 min | 20.0 | 18.9 | 19.2 | 18.9 | 19.1 | 18.5 | 19.1 | 21.8 | 21.6 | 21.3 |
| IMVR 320° C. 20′ ml/10 min | 23.2 | 20.2 | 20.4 | 19.7 | 21.1 | 18.8 | 20.0 | 22.2 | 22.8 | 21.9 |
| IMVR 320° C. 30′ ml/10 min | 26.7 | 21.2 | 21.6 | 19.8 | 20.7 | 19.4 | 21.1 | 22.4 | 23.4 | 22.2 |
| Delta MVR/IMVR20′ 320° C. | 3.2 | 1.3 | 1.2 | 0.8 | 2.0 | 0.3 | 0.9 | 0.4 | 1.2 | 0.6 |
| Delta MVR/IMVR30′ 320° C. | 6.7 | 2.3 | 2.4 | 0.9 | 1.6 | 0.9 | 2.0 | 0.6 | 1.8 | 0.9 |

It can be seen that each polycarbonate composition which additionally contains a phosphate of the formula (1) or (2) (here TOF) has a significantly higher melt stability. This can be seen from the parameter delta MVR: For each phosphate-containing example according to the invention, delta MVR is smaller than the associated value of the comparison example. This applies both to the class of phosphites and phosphonites and to mixtures of phosphites with sterically hindered phenols (synergistic mixtures).

Further examples with UV-protected compositions with added phenol:

Makrolon 2808 (BPA polycarbonate with an MVR of 10 cm³/10 min at 300° C./1.2 kg, Bayer MaterialScience), to which various UV absorbers and also phenol are added, was likewise used for Examples 11 and 12. It is known that these compounds with a free hydroxyl function lead to severe degradation of polycarbonates during storage, in particular in combination with thermal stress.

TABLE 3

| | MVR @ | | | MVR @ | | | |
|---|---|---|---|---|---|---|---|
| | 320° C. | | | 340° C. | | | Additive |
| Example | 20 | 30 | delta | 20 | 30 | delta | compounded in |
| 11 | min | min | MVR | min | min | MVR | (0.2%) |
| a | 19.8 | 20.0 | 0.2 | 32.5 | 33.0 | 0.5 | blank sample |
| b | 20.8 | 21.8 | 1.0 | 34.9 | 37.0 | 2.1 | Tinuvin 329 |
| c | 20.9 | 21.1 | 0.2 | 35.2 | 38.1 | 2.9 | Tinuvin 360 |
| d | 24.5 | 26.2 | 1.7 | 44.3 | 57.4 | 13.1 | phenol |
| | | | | | | | Additive |
| | | | | | | | compounded in |
| Example | 20 | 30 | delta | 20 | 30 | delta | (0.2%) + TOF |
| 12 | min | min | MVR | min | min | MVR | (100 ppm) |
| a | 20.2 | 20.4 | 0.2 | 33.2 | 33.1 | −0.1 | blank sample + |
| | | | | | | | TOF |
| b | 20.8 | 21.1 | 0.3 | 34.4 | 35.4 | 1.0 | Tinuvin 329 + |
| | | | | | | | TOF |
| c | 20.3 | 20.6 | 0.3 | 34.2 | 34.6 | 0.4 | Tinuvin 360 + |
| | | | | | | | TOF |
| d | 21.0 | 21.1 | 0.1 | 34.1 | 34.9 | 0.8 | phenol + TOF |

The comparison of the compositions according to the invention in Table 3 which contain the phosphates according to the invention with the corresponding comparison examples shows a significantly higher melt stability, i.e. a smaller change in the MVR than in the comparison samples without the phosphate. This demonstrates the melt-stabilizing action of the phosphates in the polycarbonate compositions according to the invention.

1-15. (canceled)

16. A method for improving the melt stability of a polycarbonate composition comprising compounds comprising phenol groups or a polycarbonate comprising phenol groups, comprising
adding 30 to 300 ppm of at least one phosphorus compound of formula (1) 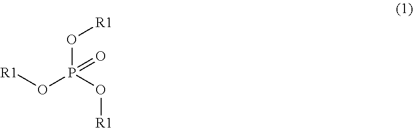
wherein R1 is selected from the group consisting of branched alkyl radicals, aryl radicals and substituted aryl radicals, wherein the at least one phosphorus compound of formula (1) is tri-isooctyl phosphate, and
optionally a further phosphorus compound of formula (1) or a phosphorus compound of formula (2) 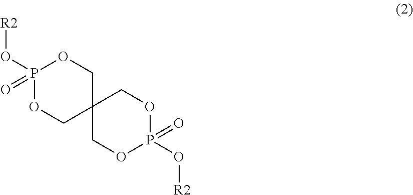
wherein R2 is selected from the group consisting of branched alkyl radicals, aryl radicals and substituted aryl radicals.

17. The method of claim 16, wherein the polycarbonate composition additionally comprises at least one heat stabilizer selected from the group consisting of sterically hindered phenols and compounds of formulae (5) through (8): 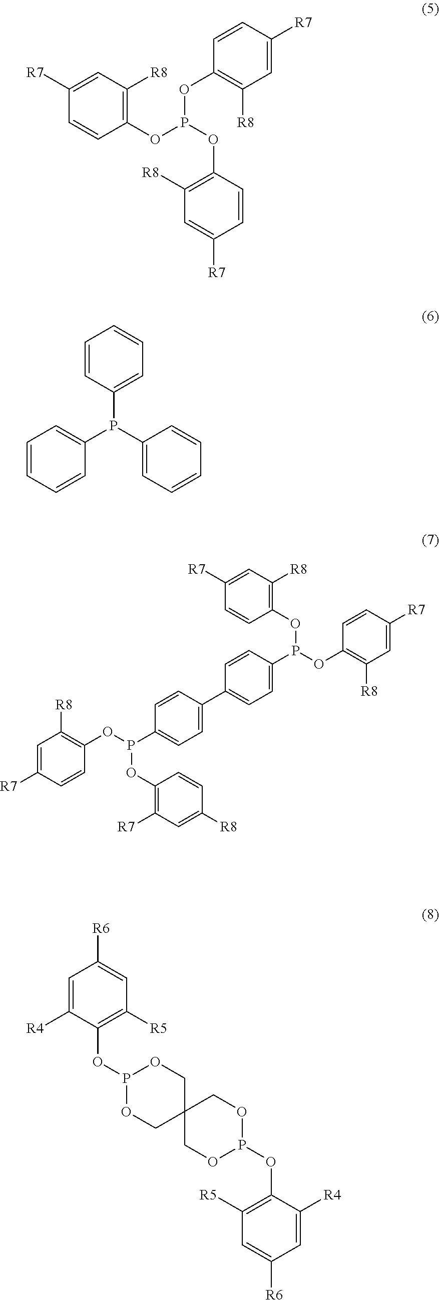
wherein R4, R5, R6, R7 and R8 in each case independently of each other and among one another are H, a C₁-C₈-alkyl radical, a phenyl radical, or a substituted phenyl radical.

18. The method of claim 16, wherein the alkyl radical is a C1-C18-alkyl and the aryl radical is an aryl radical substituted by C1-C8-alkyl, branched C1-C8-alkyl or cumyl, wherein the substituents can be identical or different.

19. The method of claim 16, wherein the polycarbonate composition prises at least one additive selected from the group consisting of UV stabilizers, heat stabilizers, mould release agents, and colouring agents.

20. The method of claim 19, wherein the UV absorber is selected from the group of benzotriazoles, triazines, cyanoacrylates or malonates.

21. The method of claim 19, wherein the content of UV stabilizer is from 0.1 wt. % to 0.4 wt. %, based on the total composition.

22. The method of claim 19, wherein the content of heat stabilizer, based on the total weight of the composition, is 30 to 600 ppm.

23. The method of claim 17, wherein the ratio of the heat stabilizers to the phosphorus compounds of the formula (1) and (2) is between 4:1 to 1:4.

24. The method of claim 17, wherein the polycarbonate has a molecular weight Mw of from 10,000 to 200,000.
